(19) United States
(12) Patent Application Publication
(10) Pub. No.: US 2006/0190251 A1
(43) Pub. Date: Aug. 24, 2006

(54) Memory usage in a multiprocessor system

(76) Inventors: Johannes Sandvall, Lund (SE); Erik Montnemery, Lund (SE)

Correspondence Address: POTOMAC PATENT GROUP, PLLC, P. O. BOX 270, FREDERICKSBURG, VA, 22404, US

(21) Appl. No.: 11/065,684

(22) Filed: Feb. 24, 2005

(51) Int. Cl. G10L 15/00

(52) U.S. Cl. 704/236

(57) ABSTRACT

A multiprocessor system for receiving and processing data packets includes a host processor, at least one client processor, and a memory accessible to the at least one client processor. The host processor is programmable to analyze a received data packet, and based thereon to obtain information on at least one codebook needed to process additional data and to generate at least one codebook packet. The at least one client processor is programmable to receive the at least one codebook packet and additional data and to use information in the received codebook packet to unpack the additional data. The memory is controlled by the host such that information in the received codebook packet is selectively stored by the client processor in the memory. The host processor is also programmable to analyze, based on the data packet, the information used by the at least one client processor. Methods of using a memory in a multiprocessor system and computer-readable media containing computer programs for using a memory in a multiprocessor system are also disclosed.

### BACKGROUND

This invention relates to electronic digital signal processing and more particularly to such processing in multiprocessor systems.

Lossy compression of audio data has gained widespread acceptance, especially for on-line distribution of music. Lossy audio compression methods achieve high compression by removing perceptual irrelevancies and statistical redundancies in the original data. Compared to lossless audio coding, in which a typical data rate is about 10 bits/sample, lossy coding can yield data rates of less than 1 bit/sample with fidelity that is perceived as acceptable by many people.

One lossy compression algorithm that is popular today is MPEG 1 Layer 3, or MP3, which has gained widespread acceptance despite its flaws and limitations. A notable limitation is that MP3 does not support more than two audio channels. Other coder/decoders (codecs) feature both better compression and fewer limitations than MP3. These codecs are sometimes called “second-generation” codecs, and they use more modern compression techniques (e.g., psycho-acoustic models, temporal noise shaping, etc.) and impose fewer restrictions on the audio streams being processed.

Among the proprietary second-generation codecs are the advanced audio codec (AAC), which is used to compress the audio data in DVD-format movies and the like, AC3 from Dolby Laboratories, which is used in high-definition television (HDTV), and Windows Media Audio (WMA), which is a codec developed by Microsoft. Ogg/Vorbis is another second-generation codec that is technically on a par with the others and that remains totally free to use. As the name suggests, Ogg/Vorbis is a combination of Ogg, a general-purpose container stream format, and Vorbis, a lossy psycho-acoustic audio codec. In general, psycho-acoustic coding removes sound that is inaudible to the human ear based on a generalized model of the human auditory system.

An Ogg/Vorbis data stream comprises Vorbis packets embedded in an Ogg bit stream. An Ogg bit stream is a container stream format able to hold data of many kinds. A Vorbis packet can be one of four types: identification, comment, setup, and audio. The identification packet identifies a stream as Vorbis and specifies version and audio characteristics, sample rate, and the number of channels. An identification packet must be directly followed by a comment packet or another identification packet (which will reset the setup process). A comment packet contains title, artist, album, and other meta information. A comment packet must be directly followed by a setup packet or an identification packet (which will reset the setup process). A setup packet specifies codec setup information, vector quantization, and Huffman codebooks. A setup packet must be directly followed by an audio packet or an identification packet (which will reset the setup process). An audio packet contains audio data.

In many audio coders, a set of Huffman codebooks, or lookup tables, is used for entropy (lossless) compression of already transformed and psycho-acoustically processed audio data. The decoder needs the same set of codebooks to decompress the compressed data stream. Each packet of compressed data typically specifies the codebook(s) needed to decompress the packet.

Some audio compression formats, e.g., MP3 and AAC, use standard sets of codebooks, and others, e.g., OggVorbis, let the encoder determine the codebooks. For the latter type of encoders, the behavior of a compatible decoder is specified down to the bit level of processed data packets, but nothing is specified about how the data packets are generated, i.e., encoded. This facilitates encoder improvements over time, but necessitates including the codebooks as part of the encoded bit stream.

Codecs using standard sets of Huffman codebooks can store the tables in advance in read-only memory (ROM). Such advance storage is not possible when the tables are sent in the encoded data stream. Thus, the required transmission data rate, or bit rate, needs to be increased due to the transmission of the codebooks. Current versions of Ogg/Vorbis include roughly 16 kilobytes (kB) of codebooks in its audio stream, which at a data rate of 128 kilobits/second (kbps) means a delay of about one second before playback can begin.

In codec applications, among others, it is common to carry out data processing tasks and control-related tasks in different sub-processors of a multiprocessor system, such as a combination of a general-purpose central processing unit (CPU) and one or more digital signal processors (DSPs). DSPs are a specialized class of CPUs that are optimized for signal processing tasks, i.e., highly repetitive and numerically intensive tasks. Many DSPs have a Harvard architecture, involving either separate data and instruction memories or separate busses to a single, multiported, memory. The CPU typically has a large amount of available storage, such as random access memory (RAM), while the DSP typically has a more limited amount of high-speed storage, such as static random access memory (SRAM). In existing multiprocessor systems, the memory needed for codebooks may use up a substantial amount of the available storage (RAM or ROM), which can be a serious problem, especially for embedded systems, such as those in mobile devices.

### SUMMARY

In accordance with one aspect of this invention, there is provided a multiprocessor system for receiving and processing data packets. The system includes a host processor, at least one client processor, and a memory accessible to the at least one client processor. The host processor is programmable to analyze a received data packet, and based thereon to obtain information on at least one codebook needed to process additional data and to generate at least one codebook packet. The at least one client processor is programmable to receive the at least one codebook packet and additional data and to use information in the received codebook packet to unpack the additional data. The memory is controlled by the host such that information in the received codebook packet is selectively stored by the client processor in the memory. The host processor is also programmable to analyze, based on the data packet, the information used by the at least one client processor.

In another aspect of this invention, there is provided a method of using a memory in a multiprocessor system that includes a host processor, at least one client processor, and a memory that is accessible to the at least one client processor and that is inaccessible to the host processor. The method includes the steps of receiving a data packet in the host processor; determining, based on the received data packet, codebook data needed to process additional information; analyzing codebook data usage by the client processor; based on the analyzing step, generating at least one codebook packet that includes codebook data needed to process the additional information and sending the codebook packet and the additional information to the at least one client processor; receiving the codebook packet and the additional information in the client processor; and storing codebook data from the codebook packet in the memory at an address indicated in the codebook packet.

In yet another aspect of the invention, there is provided a computer-readable medium containing a computer program for using a memory in a multiprocessor system that includes a host processor, at least one client processor, and a memory that is accessible to the at least one client processor and that is inaccessible to the host processor. The computer program performs the steps of determining, based on a data packet received by the host processor, codebook data needed to process additional information; analyzing codebook data usage by the client processor; based on the analyzing step, generating at least one codebook packet that includes codebook data needed to process the additional information and sending the codebook packet and the additional information to the at least one client processor; receiving the codebook packet and the additional information in the client processor; and storing codebook data from the codebook packet in the memory at an address indicated in the codebook packet.

### BRIEF DESCRIPTION OF THE DRAWINGS

The several features, objects, and advantages of this invention will be understood by reading this description in conjunction with the drawings, in which:

FIG. 1 depicts a multiprocessor system;

FIG. 2 depicts a multiprocessor system having a codebook memory;

FIG. 3A depicts a data stream according to a conventional protocol;

FIG. 3B depicts a data stream according to an extended protocol;

FIG. 4 depicts a memory model; and

FIGS. 5A and 5B are flow charts of a method of memory use in a multiprocessor system.

### DETAILED DESCRIPTION

The following description is given in terms of an audio decoder, and in particular an Ogg/Vorbis decoder, but it will be understood that this is done simply for convenience. This invention can be embodied in multiprocessor systems that implement many different data processing tasks that are divided between or among sub-processors. For just a few of many possible examples, the data may be audio and/or video data, still-image data, etc. that is processed according to many different algorithms.

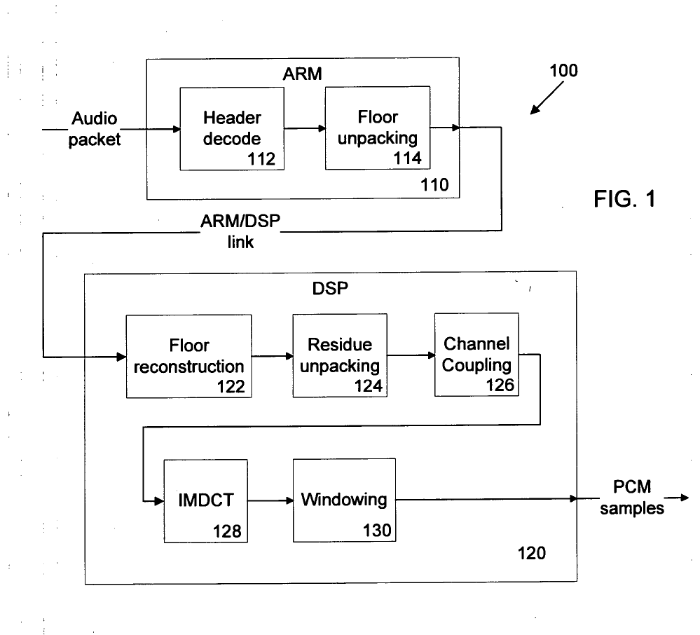

FIG. 1 depicts a multiprocessor system 100 that includes a host CPU 110 and a client DSP 120. The arrow in FIG. 1 indicates communication paths, e.g., busses and direct memory access (DMA) paths, between the CPUs 110, 120. As indicated in the figure, the host CPU may be an advanced RISC machine (ARM), and the DSP may be one of the TMS320C55xx devices made by Texas Instruments, but other hosts and/or DSPs can be used. It will be appreciated that although FIG. 1 shows only one client processor 120, more can be provided. It will also be appreciated that the host and client processors may be any programmable electronic processors.

With suitable programming, the system 100 can act as a decoder, and FIG. 1 also depicts how Ogg/Vorbis audio decoding tasks are advantageously split between the host 110 and DSP 120. In general, control tasks, e.g., high-level parsing of the input stream of audio data packets, are run on the host CPU 110 and data processing tasks, e.g., decoding, or decompressing, particular data in the data stream, are run on the DSP 120.

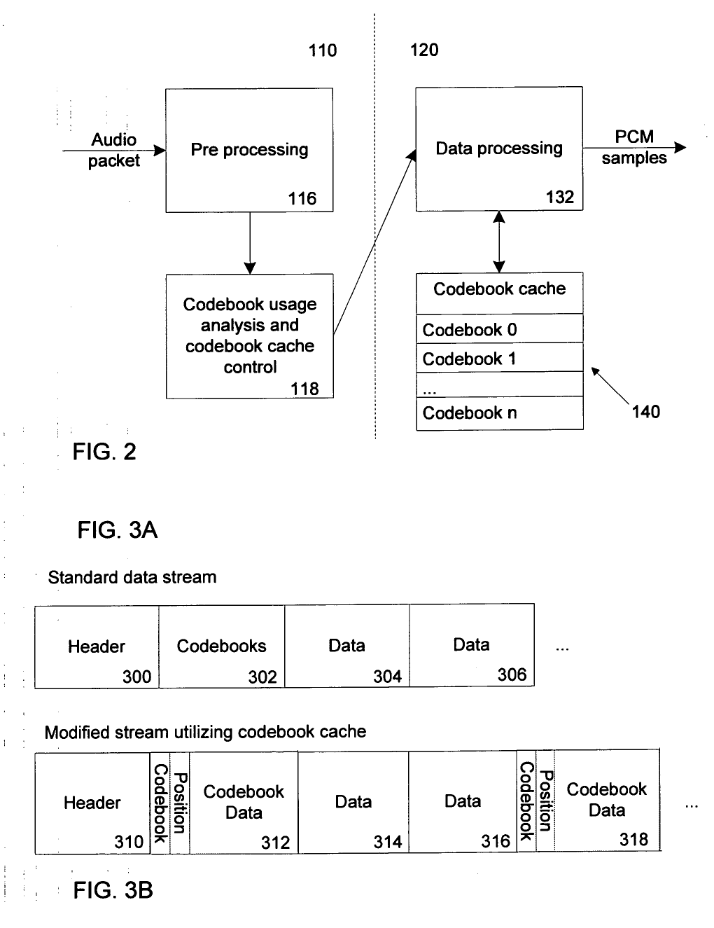

As depicted in FIG. 1, the host 110 operates to decode the header of each arrived packet of encoded audio data in a block 112, thereby identifying the type of the received packet. If the packet is an audio packet, the host 110 then operates to unpack the “floor function” of the data in a block 114. It will be understood that the frequency spectrum of the decoded audio data can be thought of as a mathematical function (the floor function) with accompanying residues. During encoding, the floor function is determined and then subtracted from the frequency spectrum, leaving the residues. The floor function is thus an approximation of the spectral envelope of the data, and this is represented by some codecs as a piece-wise-continuous polynomial. This polynomial is packed, or encoded according to a set of Huffman codebooks, at the encoder, with the result included in the encoded data packet. The host 110 also performs other tasks, which are described in more detail below in connection with FIG. 2.

The DSP 120 operates to complete the decoding of an arrived data packet by reconstructing the unpacked floor function in a block 122. The residues, which had been vector-quantized and Huffman-coded, are unpacked in a block 124, and audio channels are coupled in a block 126. The data is then transformed from the frequency domain to the time domain by an inverse modified discrete cosine transform (IMDCT) implemented in a block 128, and then the transformed time-domain data is windowed, or smoothed, in a block 130. The results are output by the DSP 120 as a stream of pulse-code-modulated (PCM) samples of the decoded audio signal.

For more details of these Vorbis encoding and decoding processes, the interested reader is directed to the Vorbis specification, which is available on the internet at, for example, www.xiph.org/ogg/vorbis/doc/Vorbis₁₃ I₁₃ spec.pdf. The artisan will understand that many codecs carry out processes that are equivalent for purposes of this invention. The artisan will also understand that the term “codebook” is not limited to a literal codebook, as in an Ogg/Vorbis codec, but should be interpreted more broadly as referring to information that is needed for processing, e.g., decoding, other information.

In existing decoders, the memory needed for codebooks may use a substantial amount of the available storage (RAM or ROM). The inventors have observed that there can be a strong correlation between codebooks needed to decode earlier and later arrived packets, and some codebooks may be used infrequently or needed only for decoding initial data. These phenomena can be observed in a typical Ogg/Vorbis data stream, for example, and since existing systems do not exploit these phenomena, the memory used for storing codebooks is used inefficiently in many existing systems. This application describes how these phenomena can be exploited to improve memory resource management in a multiprocessor system, such as that depicted by FIG. 1.

By implementing all functions regarding Ogg bit stream handling and parsing, error checking, etc. in the host processor 110, memory usage on the client DSP 120 can be reduced at the same time that host CPU usage and the data rate of communications between the processors are kept low. Moreover, since some codebooks are used exclusively for encoding floor coefficients, floor coefficients can be decoded by the host 110 and residues can be decoded by the DSP 120, thereby reducing the number of codebooks that have to be stored on the DSP and further reducing DSP memory usage. In the case of Ogg/Vorbis, the DSP memory used for storing codebooks may be decreased from 50 kB to 10 kB as the data rate between the host 110 and the client 120 is increased by approximately a factor of two. For example, a typical song encoded at a data rate of 120 kbps results in a data rate of 240 kbps between the host and the DSP. The residues can also be decoded by the host, thereby reducing DSP memory usage even more, but the data rate between the processors increases to an amount comparable with an uncompressed PCM stream, i.e., 1.4 megabits per second (Mbps) for stereo sampled at 44.1 kilohertz with 16-bit amplitude resolution.

In particular, a codebook cache memory 140 is provided as depicted in FIG. 2. The arrows in FIG. 2 indicate communication paths, e.g., busses and DMA paths, between the CPUs and the memory. The dashed line in FIG. 2 depicts the hardware boundary between the host and client processors, in this example, the ARM 110 and the DSP 120. The memory 140 may be a non-persistent type of memory, e.g., static RAM, and may for example be a memory included in the DSP device. Many commercially available DSP devices include on-chip memories, such as single-access RAM (SARAM) and dual-access RAM (DARAM). A pre-processing block 116 in FIG. 2 corresponds to the blocks 112 and 114 in FIG. 1, and a data processing block 132 in FIG. 2 corresponds to the blocks 122, 124, 126, 128, and 130 in FIG. 1.

As indicated by the figure, the memory 140 can advantageously be all or part of a memory that is accessible (read and write) by the client 120 and that is inaccessible by the host 110. In that respect, the memory 140 is different from a computer system's typical cache memory. The traditional definition of a cached memory is a system consisting of a smaller higher-speed memory (the cache) and a larger lower-speed memory, in which the high-speed memory relieves the low-speed memory by automatically storing, or “caching”, the latest read or write transactions performed on the low-speed memory. Subsequent reads or writes to the same memory area can then be performed on the high-speed memory instead of on the low-speed memory. A “cache miss” refers to the situation where requested data is not available in the cache but has to be fetched from the larger memory. The memory 140 also differs from a traditional cache in that its management is not handled by the user, in this case the client 120, but is instead handled remotely, in this case by the host 110, and in that no cache misses can occur; the memory 140 is anticipatively updated by the host 110 by its sending codebook packets.

As depicted in FIG. 2, the host 110 further operates to carry out codebook usage analysis and control of the cache 140 in a block 118. This is achieved for each data packet by extracting a list of codebooks used when processing the packet and if necessary sending the codebook(s) to the client 120 as explained below.

Through the block 118, the memory 140 is managed by the host CPU 110, i.e., on the control side. In controlling the memory 140, the host 110 sends codebooks to the client 120, i.e., the processing side, by inserting them in the data stream as the codebooks are needed by the client. A suitable format for the information sent by the host to the client is described below in connection with FIGS. 3A, 3B. As explained above, the codebook(s) or other information sent to the client are those needed by the client for its tasks, e.g., unpacking the residues in the case of an Ogg/Vorbis decoder. Only those lookup tables in actual use by the client need to be kept in the client's memory, i.e., the memory 140, although it can be advantageous for the client to retain codebooks used to decode previous data packets. This creates a trade-off between a higher rate for information sent from the host to the client, if the codebook cache memory is small, and higher memory usage by the DSP, if the codebook cache is large.

When sending a new codebook to the client 120, the host 110 informs the client of the address in the cache 140 at which the new codebook is to be stored. As depicted in FIG. 2, the codebook memory 140 includes locations at which one or more codebooks can be stored. The host may also instruct the client where to move codebooks already in the memory, i.e., codebooks previously sent to the client. In formulating its instructions, the host may consider codebook age by replacing the codebooks least recently or least frequently used when a cache update is necessary. Codebook length may also be considered. For an Ogg/Vorbis stream, the length of a codebook can typically vary between just a few tens of entries to more than a thousand.

Since the cache 140 is managed by the host 110, the client 120 need not check for overflows of the cache. The host can store many if not all of the codebooks it receives in arriving packets in the host's memory. The host can instead generate the lookup tables at run time, but this may delay production of the first decoded sample.

Although the cache memory 140 is located on the processing CPU 120, the control CPU 110 controls the cache structure and is responsible for ensuring that the codebook(s) and/or other information needed to decode or process a packet are available to the processing CPU 120 at the right time. This is made possible by uni-directional control protocol messages that the host 110 embeds in the data stream sent from the processor 110 to the processor 120. As a particular example of such extension, the Ogg/Vorbis protocol can be modified by using packets of a new type, containing both client-needed codebook data and position(s) in the codebook cache memory 140.

FIG. 3A depicts a data stream according to a generalized codec packet protocol in which codebooks needed by the decoder are included in the data stream, and FIG. 3B depicts a data stream according to an extended protocol that includes “codebook”-type packets. In FIG. 3A, the stream includes a header packet 300, a packet 302 that includes the needed codebooks, and two or more data packets 304, 306 to be decoded. The header packet 300 of FIG. 3A corresponds to the identification and comment packets that identify a stream as Vorbis and specify version and audio characteristics, sample rate, the number of channels, and title, artist, album, and other meta information. The codebook packet 302 of FIG. 3A corresponds to an Ogg/Vorbis setup packet, which specifies codec setup information, vector quantization, and Huffman codebooks. Ogg/Vorbis audio packets correspond to the data packets 304, 306 in FIG. 3A.

FIG. 3B depicts a data stream according to an extended, or modified, generalized protocol, and as explained above, this protocol is advantageously used for information sent from the host 110 to the client 120. It will be understood that this modified protocol could also be used for other communications. Briefly stated, the modified protocol provides what may be called “codebook packets” 312, 318. Since the codebook cache memory 140 is managed remotely by the host 110 instead of locally by the client 120, the information needed for cache management, e.g., the address(es) at which the codebook data is to be stored, is contained in the codebook packets 312, 318. In addition, the codebook(s) and/or other information needed by the receiving processor for handling one or more subsequent data packets 314, 316 are contained in the codebook packets. The receiving processor, such as the client 120, stores the codebook(s) and information in the cache memory 140 at the address(es) indicated by the codebook packet(s). As depicted by the two examples 312, 318 included in FIG. 3B, each codebook packet may include a portion that identifies the packet as a codebook packet. The length of a codebook packet may be permitted to vary, depending for example of the number and length(s) of the included codebook(s) or information. The header packet 310 shown in FIG. 3B contains information for setting up the client 120. The header packet 310 in FIG. 3B could be the same as the header packet 300 in FIG. 3A, but for efficiency reasons, information for setting up the host 110 can be omitted.

As noted above, a multiprocessor system such as that depicted in FIG. 1 can with suitable programming act as a decoder that includes a codebook cache memory as depicted in FIG. 2 and uses a packet protocol such as that depicted in FIG. 3B. For an Ogg/Vorbis decoder, program code can advantageously be developed with Tremor, which is an open-source fixed-point implementation of a Vorbis decoder that is available from Xiph.org. Nevertheless, it will be understood that other programming tools can be used besides Tremor.

A low-memory version of Tremor is aimed at DSP decoding and uses substantially less memory than the general-purpose version of Tremor, but with a CPU-usage penalty. Ogg stream parsing, i.e., retrieving Vorbis data from an Ogg/Vorbis stream, is built in, and a Tremor Ogg/Vorbis decoder does not need any libraries other than the standard C library. Data stream input/output is done with a callback interface, and thus the decoder does not need any knowledge of the nature of the decoded stream. Tremor is written in the portable C programming language, which is designed for easy porting and integration in larger projects. A Tremor Ogg/Vorbis decoder can be compiled and execute correctly on a DSP, a Pentium-class personal computer (PC), and a Sun workstation.

Tremor handles memory by calling standard libc functions, i.e., malloc( ), calloc( ), free( ), and alloca( ). To control the amount of memory used by the decoder processes, functions providing decoder internal memory management are added by providing the decoder with as much memory as it is allowed to use at decoder instantiation. The client part of the decoder does not need free( ) if all memory is allocated when a stream is setup for decoding and freed on the beginning of a new stream. It should be noted that alloca( ) allocates memory on a decoder-internal stack instead of on the system stack. As opposed to the automatic freeing of memory when using the standard alloca( ) function, handling of the “stack pointer” is done manually upon returning from a function where temporary memory has been allocated.

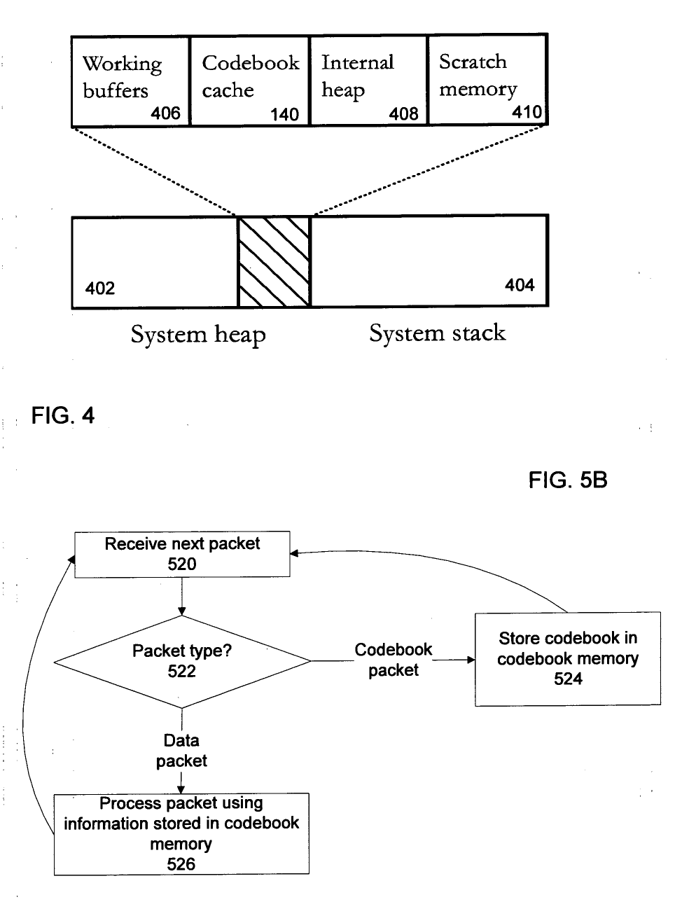

When the decoder is instantiated, the creator provides pointers to the memory chunks that will used as heap (by malloc( ) and calloc( )), as stack (by alloca( )), and in the case of the client DSP processes, the memory used as codebook cache 140. The sizes of these blocks are advantageously decided at runtime by the creator. Pointers to working buffers are also passed to the decode algorithm upon instantiation. FIG. 4 depicts a model of the client's memory, showing the system heap 402 and system stack 404, as well as the working buffers 406, codebook cache memory 140, an internal heap 408, and scratch memory 410. Since the decoder thus knows the exact amount of memory that it is allowed to use, and all memory is allocated prior to decoder execution, strict control over memory usage is achieved. If the available memory is too small, e.g., when trying to process a stream requiring a large set of codebooks, the decoder can simply report this instead of trying to allocate more memory on its own.

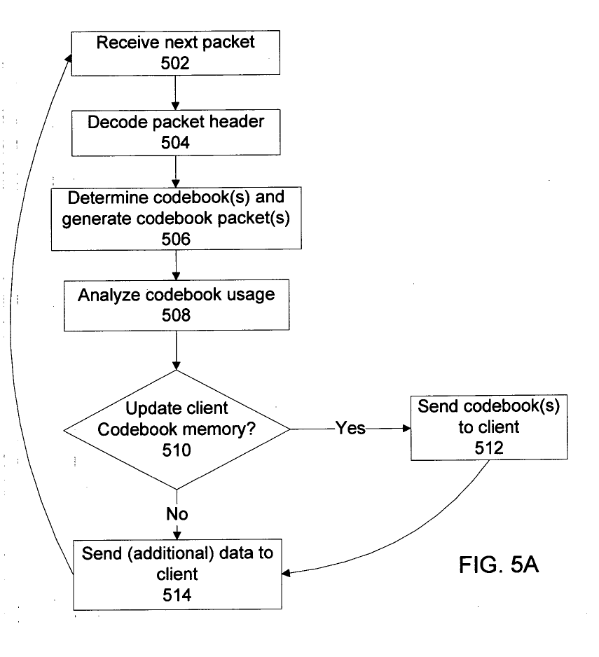

FIGS. 5A and 5B are flowcharts of a method of using a memory in a multiprocessor system as described above. It will be appreciated that this method can be implemented by suitably programming the host and client processors. Referring to FIG. 5A, the method begins in the host processor 110 with receipt of a packet (step 502). The received packet is analyzed by the host, which decodes the packet's header (step 504). If the header indicates the packet is of the proper type, the host further analyzes the received packet, e.g., determining the codebook(s) or information needed to process the data packet and generating at least one codebook packet (step 506). The codebook packet is described in more detail above in connection with FIG. 3B. The host also analyzes the codebook data usage by the client processor (step 508), for example, which codebook(s) are stored in the memory 140, how long have they been stored there, how often they have been used by the client processor 120, how long ago each was last used, etc. The host processor 110 can easily determine this information because the host manages the codebook memory 140 as described above.

The host's analysis of a received packet reveals the codebook(s) or other information needed to process additional data in this and/or other packets, and the host's management of the memory 140 reveals whether the memory already includes those codebook(s) or other information. In step 510, the host can therefore determine whether the client memory needs to be sent information, i.e., to be updated, such that the client will have access to the codebook(s) or other information needed by the client to process the additional data, such as video, audio and other data, in other packets. If the host determines that the client needs information, the host sends the needed information in one or more codebook-type packets to the client (step 512). Otherwise, the host sends the additional data to be processed, either by repackaging the data in a new data packet (see FIG. 3B) or by forwarding the received packet, to the client (step 514).

Referring to FIG. 5B, the client processor 120 receives a packet from the host processor 110 (step 520). As described above, the client processor may receive codebook packets and (additional) data packets, and the client uses received codebook data to unpack or decode the additional data. Thus, the client determines the type of packet received (step 522), and if the received packet is a codebook packet, the client stores the codebook(s) in the memory 140 at the address(es) indicated (step 524). If the packet is a data packet, the client decodes (unpacks) data in the packet using the codebook(s) or other information stored in the memory 140.

The temporal correlation of used codebooks and the fact that some codebooks might not be needed at all can be used by a codebook caching facility in a host processor to increase memory usage efficiency in a client processor in a multiprocessor system. This application describes methods and apparatus that exploit the usage patterns of codebooks included in encoded data streams. One advantage of splitting the decoding process between processors is that it enables decoding in a memory-constrained environment, e.g., an embedded system having less than 64 kB of RAM free for a DSP.

It is expected that this invention can be implemented in a wide variety of environments, including for example mobile communication devices that may handle multimedia information content. It will also be appreciated that procedures described above are carried out repetitively as necessary. To facilitate understanding, many aspects of the invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

Moreover, the invention described here can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, communicate, propagate, or transport the program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium include an electrical connection having one or more wires, a portable computer diskette, a RAM, a ROM, an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A multiprocessor system for receiving and processing data packets, comprising:
a host processor, wherein the host processor is programmable to analyze a received data packet, and based thereon to obtain information on at least one codebook needed to process additional data and to generate at least one codebook packet;
at least one client processor, wherein the at least one client processor is programmable to receive the at least one codebook packet and additional data and to use information in the received codebook packet to unpack the additional data; and
a memory that is accessible to the at least one client processor, wherein the memory is controlled by the host such that information in the received codebook packet is selectively stored by the client processor in the memory;
wherein the host processor is also programmable to analyze, based on the data packet, the information used by the at least one client processor.

2. The system of claim 1, wherein the host processor sends information in a codebook packet to the at least one client processor as the sent information is needed by the at least one client processor to unpack the additional data, and the sent information is stored in the memory.

3. The system of claim 2, wherein the at least one codebook packet includes an address in the memory at which the sent information is to be stored.

4. The system of claim 2, wherein the host processor unpacks a spectral envelope of the additional data, and the at least one client processor reconstructs the spectral envelope based on sent information.

5. The system of claim 4, wherein the spectral envelope is a piece-wise-continuous polynomial that was packed according to a set of Huffman codebooks.

6. The system of claim 4, wherein the additional data are vector-quantized residues that were packed according to a set of Huffman codebooks.

7. The system of claim 1, wherein the at least one client processor decodes and reconstructs additional data based on information in the received codebook packet, and the additional data includes at least one of audio data, video data, and image data.

8. The system of claim 7, wherein the additional data comprises residues that are packed according to a set of Huffman codebooks.

9. A method of using a memory in a multiprocessor system that includes a host processor, at least one client processor, and a memory that is accessible to the at least one client processor and that is inaccessible to the host processor, comprising the steps of:
receiving a data packet in the host processor;
determining, based on the received data packet, codebook data needed to process additional information;
analyzing codebook data usage by the client processor;
based on the analyzing step, generating at least one codebook packet that includes codebook data needed to process the additional information and sending the codebook packet and the additional information to the at least one client processor;
receiving the codebook packet and the additional information in the client processor; and
storing codebook data from the codebook packet in the memory at an address indicated in the codebook packet.

10. The method of claim 9, wherein the analyzing step includes at least one of identifying codebook data stored in the memory, determining how long codebook data has been stored there, determining how often codebook data has been used by the client processor, and determining how long ago codebook data was last used.

11. The method of claim 9, further comprising the step, in the client processor, of using stored codebook data to process the additional information.

12. The method of claim 11, wherein the host processor sends the codebook packet to the at least one client processor as the codebook data is needed by the at least one client processor to process the additional information.

13. The method of claim 12, wherein the host processor unpacks a spectral envelope of the additional information, and the at least one client processor reconstructs the spectral envelope based on sent additional information.

14. The method of claim 13, wherein the spectral envelope is a piece-wise-continuous polynomial that was packed according to a set of Huffman codebooks.

15. The method of claim 13, wherein the additional information includes vector-quantized residues that were packed according to a set of Huffman codebooks.

16. The method of claim 9, wherein the at least one client processor decodes and reconstructs additional information based on codebook data in the received codebook packet, and the additional information includes at least one of audio data, video data, and image data.

17. The method of claim 16, wherein the additional information comprises residues that are packed according to a set of Huffman codebooks.

18. A computer-readable medium containing a computer program for using a memory in a multiprocessor system that includes a host processor, at least one client processor, and a memory that is accessible to the at least one client processor and that is inaccessible to the host processor, wherein the computer program performs the steps of:
determining, based on a data packet received by the host processor, codebook data needed to process additional information;
analyzing codebook data usage by the client processor;
based on the analyzing step, generating at least one codebook packet that includes codebook data needed to process the additional information and sending the codebook packet and the additional information to the at least one client processor;
receiving the codebook packet and the additional information in the client processor; and
storing codebook data from the codebook packet in the memory at an address indicated in the codebook packet.

19. The computer-readable medium of claim 18, wherein the analyzing step includes at least one of identifying codebook data stored in the memory, determining how long codebook data has been stored there, determining how often codebook data has been used by the client processor, and determining how long ago codebook data was last used.

20. The computer-readable medium of claim 18, wherein the computer program further performs the step, in the client processor, of using stored codebook data to process the additional information.

21. The computer-readable medium of claim 20, wherein the computer program causes the host processor to send the codebook packet to the at least one client processor as the codebook data is needed by the at least one client processor to process the additional information.

22. The computer-readable medium of claim 18, wherein the computer program causes the at least one client processor to decode and reconstruct additional information based on codebook data in the received codebook packet, and the additional information includes at least one of audio data, video data, and image data.
